(19) United States
(12) Patent Application Publication
(10) Pub. No.: US 2026/0227131 A1
(43) Pub. Date: Aug. 6, 2026

(54) COOLING ARRANGEMENT AND METHOD FOR COOLING AT LEAST ONE OIL-TO-AIR EXTERNAL HEAT EXCHANGER

(71) Applicant: Hitachi Energy Ltd, Zürich (CH)

(72) Inventors: Ulf Sand, Västerås (SE); Rebei Bel Fdhila, Västerås (SE); Lokman Hosain, Västerås (SE)

(21) Appl. No.: 19/126,543

(22) PCT Filed: Nov. 10, 2023
(86) PCT No.: PCT/EP2023/081464

§ 371 Date: May 1, 2025

(30) Foreign Application Priority Data
Nov. 11, 2022 (EP) 22207018.7

(51) Int. Cl. F28D 1/02; F28D 21/00; F28F 27/00; H01F 27/14

(52) U.S. Cl. CPC F28D 1/024; F28F 27/00; H01F 27/14; F28D 2021/0031

(57) ABSTRACT

A cooling arrangement for cooling at least one OAEHE in a transformer. The cooling arrangement includes at least one impeller-motor device, at least one fluid pipe and at least one fluid discharge device. The at least one impeller-motor device is adapted to supply a humidity-controlled fluid to the inlet of the at least one fluid discharge device via the at least one fluid pipe and cause the humidity-controlled fluid to flow through the at least one fluid discharge device and be discharged through the at least one fluid outlet of the at least one fluid discharge device in a direction of the at least one OAEHE.

### CROSS REFERENCE TO RELATED APPLICATIONS

This application is a 35 U.S.C. § 371 national stage application of PCT International Application No. PCT/EP2023/081464 filed on Nov. 10, 2023, which in turn claims foreign priority to European Patent Application No. 22207018.7, filed on Nov. 11, 2022, the disclosures and content of which are incorporated by reference herein in their entirety.

### FIELD OF THE INVENTION

Embodiments herein relate to the field of transformers. In particular, the embodiments herein relate to a cooling arrangement for cooling at least one oil-to-air external heat exchanger (OAEHE) in a transformer.

### BACKGROUND

A power transformer is equipment used in an electric grid of a power system. Power transformers transform voltage and current in order to transport and distribute electric energy. Power transformers involve high currents; therefore, production of heat is inevitable. This heat propagates in the oil inside a transformer tank. It is important to release this heat to the surroundings for the normal operation of transformers. An important part of oil-cooling is carried out by placing external devices, such as radiators, cooler banks etc., through which the transformer oil is circulated and get cooled. State-of-the art air-cooling for a transformer is performed using conventional fans, i.e., bladed fans, or natural convection. The state-of-the-art cooling of using standard fans produces high noise, has complex structure, is heavy and of difficult maintenance. For high power rated transformers, natural convection may not be enough, and therefore, forced cooling may be used for this operation.

Radiator and/or cooler banks used for transformer external cooling may occupy very large volumes, especially for high rating. The trend is to reduce the footprint, especially near residential areas mainly due to high space cost, high weight, transportation to site and complexity of the overall installation. Furthermore, temporary overloading operations in transformers is more and more used. This may cause a sudden increase in the losses and also in the oil temperatures that an installed cooling arrangement cannot handle. In this case, an additional enhancement of the cooling arrangement is useful.

The present disclosure presents an improved viable solution of a cooling arrangement.

### SUMMARY

It is an object of embodiments herein to enhance cooling of an OAEHE of a transformer.

According to an aspect the object is achieved by providing a cooling arrangement for cooling at least one OAEHE in a transformer. The cooling arrangement comprises at least one impeller-motor device, at least one fluid pipe, and at least one fluid discharge device. The at least one fluid discharge device comprises a fluid inlet for receiving a humidity-controlled fluid from the at least one fluid pipe and at least one fluid outlet arranged to direct the humidity-controlled fluid towards the at least one OAEHE. The at least one impeller-motor device is adapted to supply the humidity-controlled fluid to the inlet of the at least one fluid discharge device via the at least one fluid pipe and cause the humidity-controlled fluid to flow through the at least one fluid discharge device and be discharged through the at least one fluid outlet of the at least one fluid discharge device.

According to some embodiments, a fluid humidity may be controlled by boosting a humidity content of the fluid, e.g. by boosting the humidity content of the fluid whenever desired. This is useful because by controlling the humidity it enables to control the heat transfer coefficient in the OAEHE.

According to some embodiments, the fluid humidity may be controlled by providing a constant humidity to the fluid. This is valuable under steady state operating conditions and can allow reduction of the footprint of the OAEHE.

According to some embodiments, the temperature of the humidity-controlled fluid may be controlled. This is useful as it causes a significant enhancement of the external cooling which in turn may reduce the number of radiators in the transformer.

According to some embodiments, the humidity-controlled fluid may be generated by a device before being provided to the impeller-motor device.

According to some embodiments, the cooling arrangement may comprise a device and the humidity-controlled fluid may be generated by the device before being provided to the impeller-motor device.

According to some embodiments, the humidity content to the fluid may be added after being provided to the at least one impeller-motor device and before reaching the inlet of the at least one fluid discharge device.

According to some embodiments, the cooling arrangement may further comprise a plurality of fluid pipes that are adapted to supply humidity-controlled fluid to a plurality of fluid discharge devices.

According to some embodiments, the fluid discharge device may comprise at least one slit that is designed to be so narrow as to alter a recited physical property of the fluid stream by a recited amount due to the Bernoulli effect.

According to some embodiments, the cooling arrangement may further comprise a funnel. According to some embodiments, the at least one fluid discharge device may be arranged in the funnel. According to some embodiments, the funnel may comprise round smooth borders at an inlet of the funnel to facilitate a Coandă effect, which mitigates edge turbulence and reduces pressure drop at the inlet of the funnel

According to some embodiments, the cooling arrangement may further comprise a hose that is arranged to enhance and/or homogenize the supplied fluid.

According to another aspect the above-mentioned object is also achieved by providing a method performed by a cooling arrangement for cooling at least one OAEHE in a transformer. The cooling arrangement comprises at least one impeller-motor device, at least one fluid pipe and at least one fluid discharge device. The at least one fluid discharge device comprises a fluid inlet for receiving a humidity-controlled fluid from the at least one fluid pipe, and at least one fluid outlet. The cooling arrangement supplies the humidity-controlled fluid into the at least one fluid pipe, using the at least one impeller-motor device. The cooling arrangement further transports the humidity-controlled fluid along the at least one fluid pipe to the inlet of the at least one fluid discharge device. The cooling arrangement further causes the humidity-controlled fluid to flow through the at least one fluid discharge device. The cooling arrangement then further discharges the humidity-controlled fluid through the at least one fluid outlet in a direction of the at least one OAEHE.

Embodiments herein are based on the realisation that by providing a cooling arrangement that utilizes fluid humidity in a fluid discharge device for cooling one or more OAEHEs of a transformer, a heat transfer between the humidity-controlled fluid and the OAEHE is significantly increased. Furthermore, the cooling arrangement also utilizes surrounding fluid and/or humidity-controlled fluid, to increase the flow that is transported to the fluid discharge device. Thereby the cooling arrangement effectively provides a powerful and enhanced cooling of at least one OAEHE of a transformer.

### BRIEF DESCRIPTION OF THE FIGURES

Further technical features of the disclosure will become apparent through the following description of one or several exemplary embodiments given with reference to the appended figures, where:

FIG. 1 is a schematic overview depicting parts of a cooling arrangement based on a Bernoulli principle according to some embodiments herein;

FIG. 2 is a schematic overview depicting a cooling arrangement, according to embodiments herein;

FIG. 3 is a schematic overview depicting a fluid discharge device cross-section;

FIG. 4 is a schematic overview depicting a fluid discharge device with a hose, in accordance with some embodiments;

FIG. 5 is a flowchart depicting a method performed by a cooling arrangement according to embodiments herein;

FIGS. 6a-f are schematic overviews depicting a cooling arrangement applied to a radiator or cooled group, external to a tank of a large power transformer, in accordance with some embodiments;

FIG. 7 is a schematic overview depicting fluid discharge devices with different fluid flow rates, A, B and C; and

FIG. 8 is a schematic overview according to some embodiments.

It should be noted that the drawings have not necessarily been drawn to scale and that the dimensions of certain elements may have been exaggerated for the sake of clarity.

### DETAILED DESCRIPTION

Typically, in external transformer cooling, the multiplication factor, i.e., the ratio between total imposed flow rate and injected flow rate to an emitter ring, can vary between 10 to 50, depending on surrounding geometry, emitter ring shape and the pressure drop caused by the cooled object.

By adding content of humidity to a cooling arrangement an external cooling surface heat transfer coefficient may be increased by orders of magnitude. A substantial increase of the heat transfer coefficient may in principle enable a substantial reduction of the area for cooling, in practice meaning that the number of radiators or coolers can effectively be reduced in transformer external cooling. This will enable a reduction of cost for the external cooling of a OAEHE of a transformer.

The wording “humidity-controlled fluid” when used in this disclosure may be used interchangeably with the wording “humidity-controlled fluid flow” and represents e.g. mist or vapor such as wet or humid air.

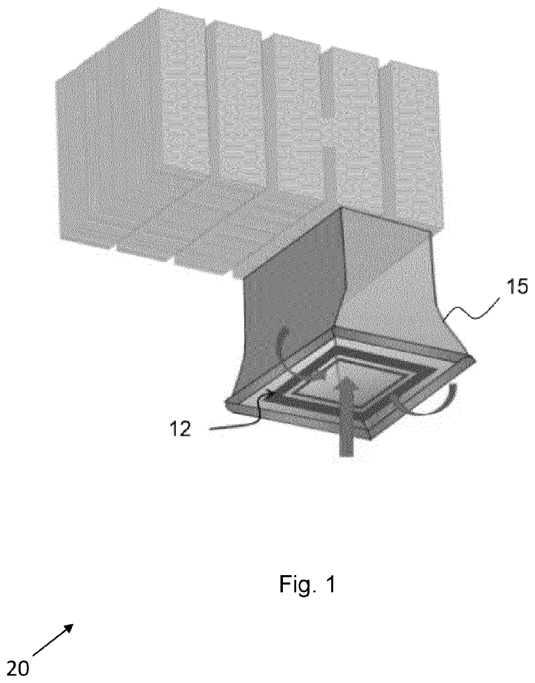

Parts of a cooling arrangement 20 according to some embodiments is illustrated in FIG. 1. The cooling arrangement 20 is based on the Bernoulli principle and comprises that a humidity-controlled fluid for a fluid discharge device 12, e.g., an emitter ring, may have been generated in a generating room. The generating room, e.g., a chamber or a housing, may be sound shielded. The humidity-controlled fluid flow is then transported to the fluid discharge device 12. The humidity-controlled fluid leaves the fluid discharge device 12 by an outlet, which may be a narrow slit, at high-speed. This will by induction and entrainment, i.e., the Bernoulli effect, which may attract air and/or fluid from the surroundings, multiply the initial fluid flow by 10 to 50 times, depending on the geometry and dimensions of the fluid discharge device 12. The fluid discharge device 12 has no electrical connections. FIG. 1 also shows a funnel 15, e.g., a funnel duct with a Coandă border, to enhance the humidity-controlled fluid flow. An OAEHE is shown in FIG. 1 in the form of a radiator.

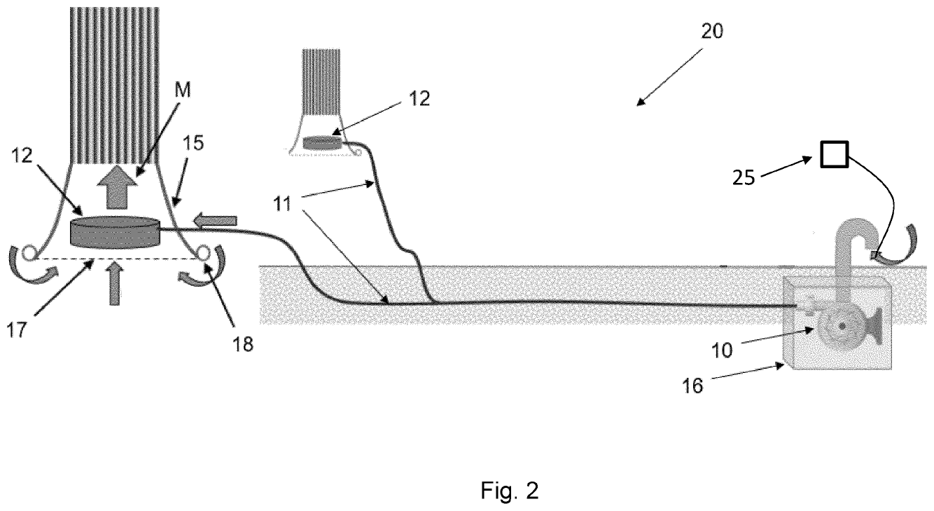

An integrated description and operation of the cooling arrangement 20 according to embodiments herein is illustrated in FIG. 2. The cooling arrangement 20 comprises at least one impeller-motor device 10, at least one fluid pipe 11 and the at least one fluid discharge device 12. The at least one fluid discharge device 12 may be hollow and comprises a fluid inlet, for receiving a humidity-controlled fluid from the at least one fluid pipe 11, and at least one fluid outlet, arranged to direct the humidity-controlled fluid towards at least one OAEHE. The cooling arrangement 20 may further comprise a funnel 15. The operation of the cooling arrangement 20 is described below:

A generated humidity-controlled fluid may be brought, e.g. provided, to the impeller-motor device 10. Also a generated fluid flow, e.g. airflow, may be provided to the impeller-motor device 10. The humidity-controlled fluid may be filtered through a filter before being brought to the impeller-motor device 10. According to some embodiments, the cooling arrangement 20 may comprise a device 25 and the humidity-controlled fluid may be generated by the device 25 before being provided to the impeller-motor device 10. The humid fluid may be mixed with fluid, such as air, and the mixing may be performed in the impeller-motor device 10. The device 25 may e.g. be a mist producer, such as a fine spray, or a humidity generator. The device 25 may be located in the generating room. The fluid humidity may be controlled by boosting the humidity content of the fluid, e.g. whenever desired. This is advantageous because by controlling the humidity it enables to control the heat transfer coefficient in the OAEHE. The fluid humidity may also be controlled by providing constant humidity to the fluid flow. This is advantageous under steady state operating conditions and can allow reduction of the footprint of the OAEHE. Furthermore, the temperature of the humidity-controlled fluid may be controlled. This enables that pre-cooled air may be provided to the impeller-motor device 10. This may also allow normal operations of the transformer in places where the ambient temperature is very high, e.g., 55 degrees Celsius. Controlling the temperature of the humidity-controlled fluid is advantageous as it causes a significant enhancement of the external cooling which in turn may reduce the number of radiators in the transformer.

The impeller-motor device 10 then supplies, e.g., accelerates, the humidity-controlled fluid flow to the fluid pipe 11. The fluid pipe 11 may comprise a thermally insulated material. The impeller-motor device 10 may be located in a housing 16 at a distance from the at least one fluid discharge device 12. This distance between the impeller-motor device 10 and the at least one fluid discharge device 12 may be of at least 1 meter, 3 meters, 5 meters or more. According to some embodiments, the at least one impeller-motor device may be located in a housing at a distance of at least 3 meters from the at least one fluid discharge device. This distance between the impeller-motor device 10 and the at least one fluid discharge device 12 is advantageous, e.g. because sound from the impeller-motor device will be generated far away from the transformer making noise mitigation procedures possible, e.g., sound-shielded housing 16 and fluid pipes 11. By transferring the origin of sound to the sound-shielded housing, the fluid discharge device 12 operation may become noise reduced by 20 to 40 dB as compared to e.g. conventional bladed fans. The housing 16 may be sound shielded, thermally insulated, may comprise thermally insulating material, may be humidity controlled, may be dustproof and/or sound absorbing. The housing 16 and the at least one fluid pipe 11 may be located underground or covered by a strong structure, which can reduce the risk of vandalism and intentional attacks to the transformer plant. According to some embodiments, the cooling arrangement 20 may comprise a plurality of fluid pipes 11 that may be adapted to supply humidity-controlled fluid to a plurality of fluid discharge devices 12.

The humidity-controlled fluid may be transported along the pipe 11 towards the inlet of the fluid discharge device 12 with minimal pressure drop. The fluid discharge device 12 may be arranged, e.g., fixated, in the funnel 15. The funnel 15 may comprise round smooth borders 18 at an inlet of the funnel 15 to facilitate a Coandă effect, which mitigates edge turbulence and reduces pressure drop at the inlet of the funnel 15. The inlet of the funnel 15 may comprise a filter grid 17. The filter grid 17 is used for preventing unwanted objects entering the OAEHE.

The humidity-controlled fluid may be forced to distribute at high pressure inside the fluid discharge device 12.

The humidity-controlled fluid is then discharged, e.g., ejected at high speed, through the outlet of the fluid discharge device 12. According to some embodiments the fluid discharge device 12 comprises at least one slit and the fluid may be discharged through the slit which may be narrow, e.g., a slit that is designed to induce the flow towards the OAEHE.

Due to the high-speed of the humidity-controlled fluid, the fluid in the back of the fluid discharge device 12 may be induced into the central region of the fluid discharge device 12. And nearby the outlet of the fluid discharge device 12, fluid and/or humid fluid is entrained. The induction and entrainment, i.e., the Bernoulli effect, may multiply the initial humidity-controlled fluid flow M by 10 to 50 times depending on the geometry and dimensions of the fluid discharge device 12.

The aerodynamics shape of the toroid-like surface of the fluid discharge device 12 and the Coandă effect enables the humidity-controlled fluid flow to be directed towards the OAEHE.

Additional humidity-controlled fluid may be added to an axial region of the fluid discharge device 12 with a hose 21.

The obtained humidity-controlled fluid flow may be increased to match the desired parameters to cool the at least one OAEHE in the transformer. A set of parameters may provide such a dedicated design. These parameters are:
a. Impeller-motor device power;
b. Fluid discharge device diameter and/or size;
c. Slit thickness;
d. Toroid-like shape of the fluid discharge device 12 and cross-section dimensions of the fluid discharge device 12. The fluid discharge device 12 may have a cross-section that is circular, oval, rectangular or any other polygonal shape. The fluid outlet of the discharge device 12 may follow the outer perimeter of the discharge device 12.

High speed humidity-controlled fluid may pass through the OAEHE, whose geometrical shape will produce a pressure drop. The remaining fluid flow may be utilized to cool down a second or more OAEHEs.

The result of the cooling arrangement 20 operation is the multiplication of the humidity-controlled fluid flow, typically by a factor of 10 to 50. The technology of the cooling arrangement 20 may utilize the surrounding fluid and/or humid fluid, to amplify the humidity-controlled fluid flow that is transported to the fluid discharge device 12. It is concluded that the cooling arrangement 20 effectively provides a powerful and efficient bulk humidity-controlled fluid flow to at the least one OAEHE of the transformer. By utilizing fluid humidity, e.g. wet/moist cooling air flow, for transformer external cooling, the heat transfer between the humidity-controlled cooling fluid and the OAEHE of the transformer may be greatly enhanced. By using Bernoulli multiplier technology, the external cooling of power transformers may thus be enhanced.

According to some embodiments, colder humidity-controlled fluid may be injected through the fluid discharge device 12, which causes a significant enhancement of the external cooling.

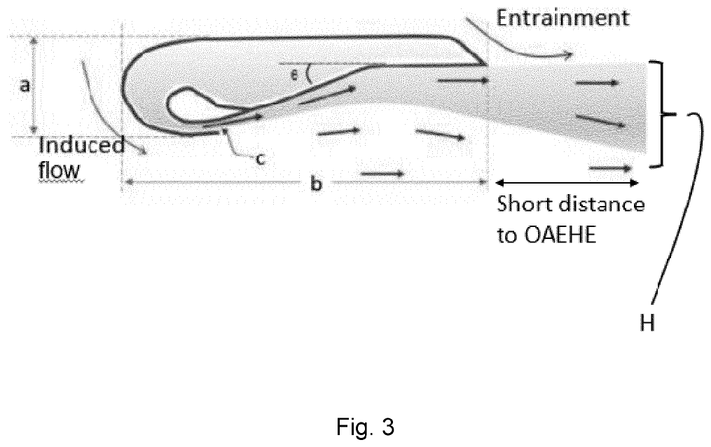

FIG. 3 illustrates a cross-section of the fluid discharge device 12. The speed of the humidity-controlled fluid flow, e.g., induced flow as shown in FIG. 3, at the outlet c of the fluid discharge device 12 is very high, e.g., >15 m/s. The relation of dimensions a, b and θ may be arranged to try to get a homogeneous fluid flow H in minimal distance to the OAEHE.

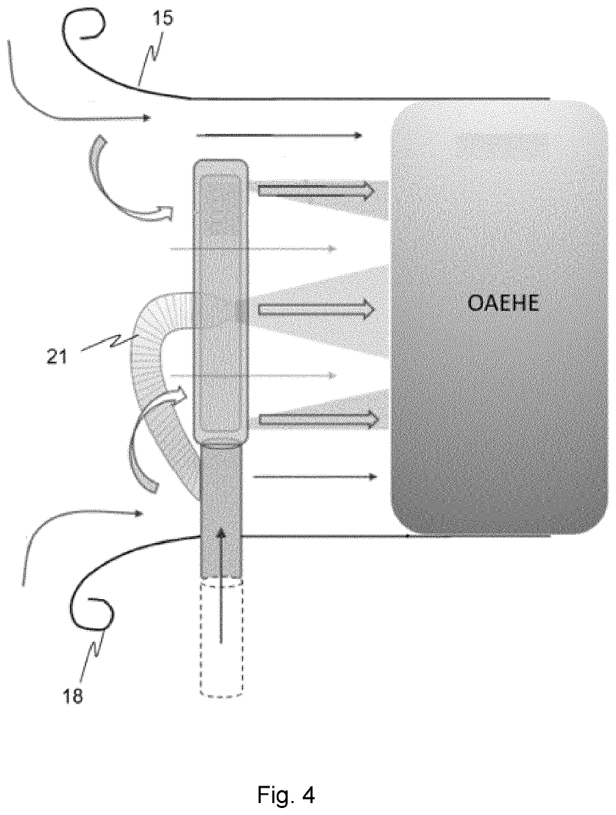

FIG. 4 illustrates the fluid discharge device 12 with an additional hose 21 according to some embodiments herein. The hose 21 may homogenize the fluid flow towards the OAEHE. The edges of the funnel 15 may be curved and comprise round smooth borders 18 instead of sharp to guide and enhance the fluid flow and facilitate the Coandă effect, which mitigates edge turbulence and reduces pressure drop at the inlet of the funnel 15.

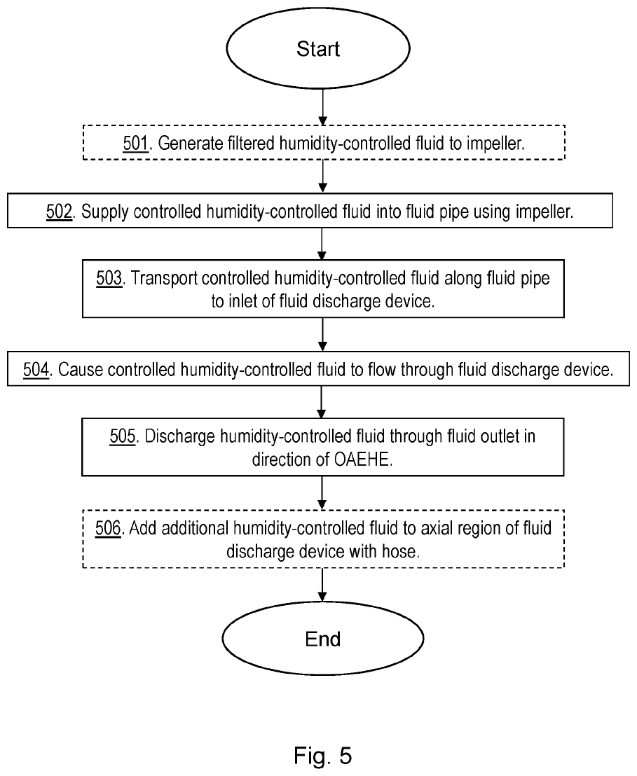

The method actions performed by a cooling arrangement 20 for cooling at least one OAEHE in a transformer, according to embodiments herein, will now be described with reference to a flowchart depicted in FIG. 5. The actions do not have to be taken in the order stated below but may be taken in any suitable order. Actions performed in some embodiments are marked with dashed boxes. The cooling arrangement 20 comprises at least one impeller-motor device 10, at least one fluid pipe 11 and at least one fluid discharge device 12. The fluid discharge device 12 comprises a fluid inlet for receiving fluid from the at least one fluid pipe 11, and at least one fluid outlet.

### Action 501

A filtered humidity-controlled fluid may be generated and provided to the at least one impeller-motor device 10. The filter is to avoid having dust and/or particles into the at least one impeller-motor device 10 and through the at least one fluid pipe 11 and the at least one fluid discharge device 12. The at least one impeller-motor device 10 may be located in a housing 16. The housing 16 may be one or more of: sound-shielded, thermally insulated, comprises thermally insulating material, humidity controlled, dustproof and/or sound absorbing.

### Action 502

The cooling arrangement 20 supplies the humidity-controlled fluid into the at least one fluid pipe 11, using the at least one impeller-motor device 10. According to some embodiments, the cooling arrangement 20 may control the fluid humidity by boosting a humidity content of the fluid, e.g. enhancing the humidity content of the fluid, e.g. whenever desired. I.e. the fluid humidity may be increased in situations when more cooling is desired. According to some embodiments, the fluid humidity may be controlled by providing a constant humidity to the fluid. In the case of steady transformer operations, the thermal load is steady, and the humidity may be provided continuously at a constant level to meet the cooling target. Higher steady humidity level may enable reduction of the footprint of the transformer external cooling. In the case of transient transformer operation such as temporary overloading, adapting humidity level may ensure the provision of the instantaneous cooling. According to some embodiments the temperature of the humidity-controlled fluid may be controlled. According to some embodiments, the humidity-controlled fluid may be generated by the device 25 before being provided to the impeller-motor device 10. According to some embodiments, filtered fluid may be generated and provided to the at least one impeller-motor device 10. According to some embodiments, the at least one impeller-motor device may be located in a housing at a distance of at least 3 meters from the at least one fluid discharge device. The cooling arrangement 20 may supply the fluid into the at least one fluid pipe 11, using the at least one impeller-motor device 10. According to some embodiments, the humidity to the fluid may be added after being provided to the at least one impeller-motor device 10 and before reaching the inlet of the at least one fluid discharge device 12. The at least one fluid pipe 11 may comprise a thermally insulated material. The cooling arrangement 20 may comprise a plurality of fluid pipes 11 that may be adapted to supply fluid to a plurality of fluid discharge devices 12. Accordingly, the term humidity-controlled fluid may mean that the fluid is controlled by one or more of: boosting a humidity content of the fluid, providing a constant humidity to the fluid and/or controlling the temperature of the fluid.

### Action 503

The cooling arrangement 20 transports the humidity-controlled fluid along the at least one fluid pipe 11 to the inlet of the at least one fluid discharge device 12. The at least one fluid discharge device 12 may be circular, oval, rectangular or any other polygonal shape. The fluid outlet of the discharge device 12 may follow the outer perimeter of the discharge device 12. The cooling arrangement 20 may comprise a funnel 15. The at least one fluid discharge device 12 may be arranged in the funnel 15. The funnel 15 may comprise round smooth borders 18 at an inlet of the funnel 15 to facilitate a Coandă effect, which mitigates edge turbulence and reduces pressure drop at the inlet of the funnel 15.

### Action 504

The cooling arrangement 20 causes the humidity-controlled fluid to flow through the at least one fluid discharge device 12.

### Action 505

The cooling arrangement 20 discharges, e.g., emits, the humidity-controlled fluid flow through the at least one fluid outlet in a direction of the at least one OAEHE. The fluid discharge device 12 may comprise at least one slit that is designed to be so narrow as to alter a recited physical property of the fluid stream by a recited amount due to the Bernoulli effect and the cooling arrangement 20 may discharge the humidity-controlled fluid through the slit in the direction of the at least one OAEHE to cool down the at least one OAEHE.

### Action 506

According to some embodiments the cooling arrangement may comprise a hose 21 that is arranged to enhance and/or homogenize the supplied fluid humidity. The cooling arrangement 20 may add additional fluid flow to an axial region of the fluid discharge device 12 with the hose 21.

Consequently, embodiments herein thus provide the cooling arrangement 20 comprising the at least one connected impeller-motor device 10, fluid pipe 11 and fluid discharge device 12 ejecting a powerful fluid flow. The impeller-motor device 10 may be located inside a housing 16 which may be protective and sound-shielded, and/or may be a thermally insulated, humidity controlled, dustproof and sound absorbing chamber. The fluid pipe 11 may be made of a robust and thermally insulating material. Examples of robust and thermally insulated materials are polymer composites which may include reinforcement such as carbon fibre. For robustness the fluid pipe 11 may also be made of metal covered by concrete. The fluid discharge device 12 may have a cross-section that is circular, oval, rectangular or any other polygonal shape. The fluid outlet of the discharge device 12 may follow the outer perimeter of the discharge device 12. The fluid discharge device 12 outlet may comprise a narrow slit, where fluid humidity exits and points towards the device to be cooled.

Embodiments herein provide external cooling to large power transformers. The proposed cooling arrangement 20 is simple, lightweight, and easy to maintain. It is also silent as it has no moving parts at the cooling site. The latter is possible due to the separation of the fluid discharge device 12 from the impeller-motor device 10 which may be confined in a housing which may be sound-shielded. Embodiments herein are based on the Bernoulli principle, which makes it possible to multiply by more than one order of magnitude of the inlet fluid flow rate provided by the impeller-motor device 10.

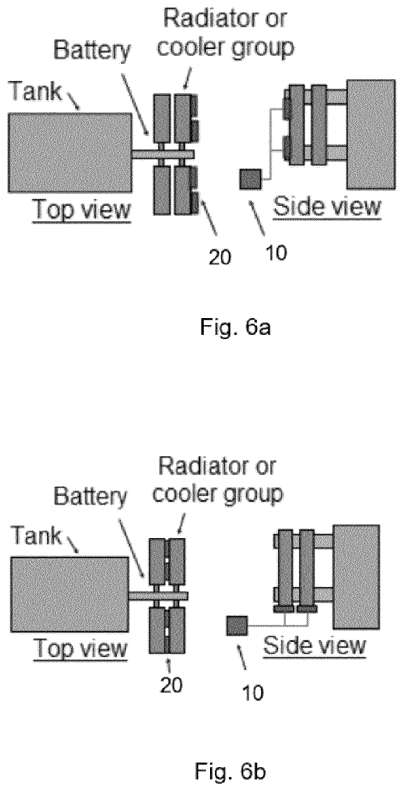

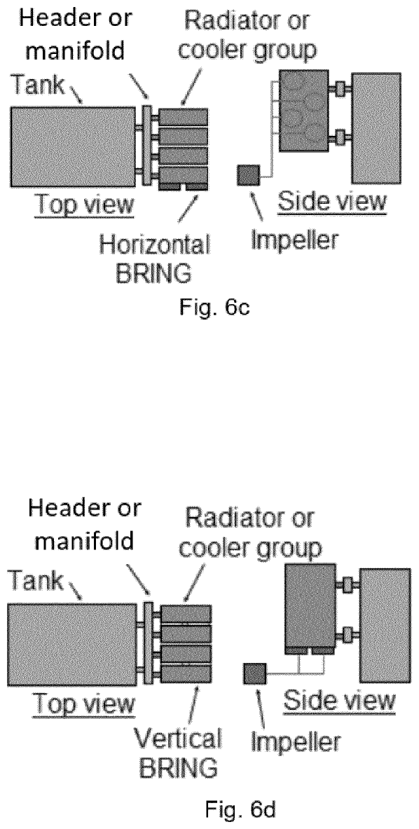

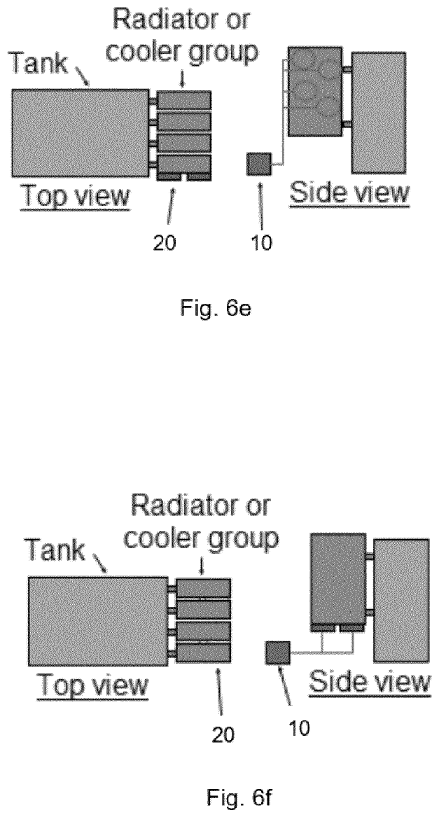

FIGS. 6a-f illustrate schematic overviews according to some embodiments, showing various possible embodiments when applying the cooling arrangement 20 to the OAEHE, e.g., a radiator or cooled group, external to a tank of a large power transformer. FIG. 6a shows a radiator on battery with a horizontal cooling arrangement 20. FIG. 6b shows a radiator on battery with a vertical cooling arrangement 20. FIG. 6c shows a radiator on a header with a horizontal cooling arrangement 20. FIG. 6d shows a radiator on a header with a vertical cooling arrangement 20. FIG. 6e shows a radiator on a tank with a horizontal cooling arrangement 20. FIG. 6f shows a radiator on a tank with a vertical cooling arrangement 20.

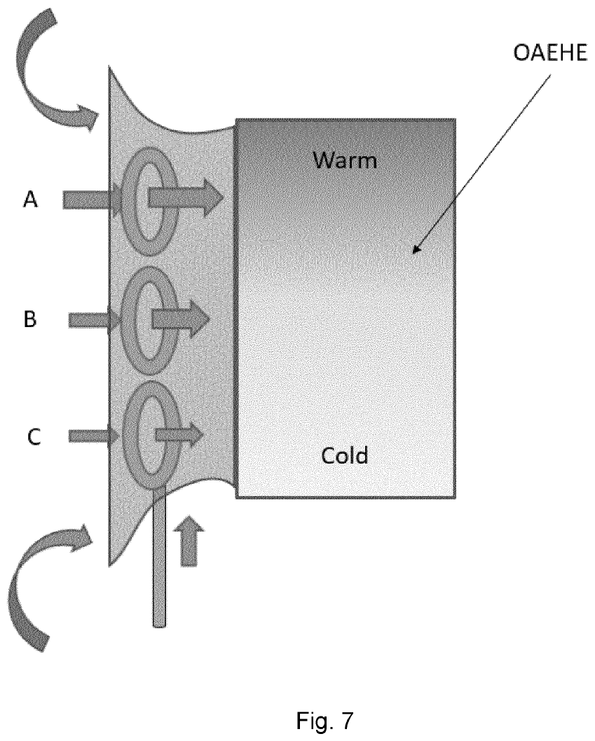

FIG. 7. illustrates a schematic overview according to some embodiments, showing three cooling fluid discharge devices 12 with different airflow rates A, B, C. Since the upper part of the OAEHE is hotter than the lower part, it is possible to design the fluid pipes 11 to give more fluid flow to the upper fluid discharge device 12, e.g., upper ring. According to some embodiments it may be possible to use three interconnected fluid discharge device 12. To avoid high pressure-drop, the fluid pipe 11 transitions may be smooth.

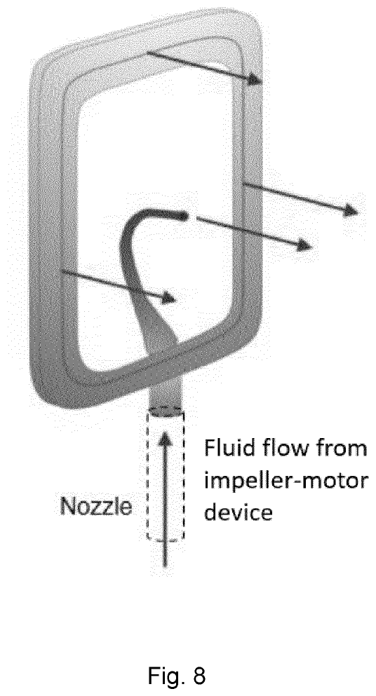

FIG. 8. illustrates a schematic overview according to some embodiments, wherein one way to compensate the fluid flow in the central region is to split the incoming fluid flow with a sharing to a central hose. (Down left).

Some advantages and benefits of embodiments herein are:
Size of the fluid discharge device 12 is proportional to the humidity-controlled fluid flow rate (flexibility: may be scaled when increased cooling desired).
Input power to the impeller-motor device 10 is proportional to the humidity-controlled fluid flow rate (flexibility: can be utilized when increased cooling desired).
Additional hose 21 along the axis of the fluid discharge device 12 can increase the humidity-controlled fluid flow rate and flow homogeneity.
Power for the cooling arrangement 20 is small as compared to the conventional bladed fans because a multiplication factor would take care of the flow rate to cool down OAEHEs.
At a temporary over-rating situation, an extended cooling fluid flow range can be effectively generated if desired.
The cooling arrangement 20 is highly efficient in an outdoor environment.
The impeller-motor device 10 can be separated from the fluid discharge device 12 making it possible to achieve beneficial actions such as sound isolation coming from the impeller-motor device 10.
Noise is reduced at least by 25 dB with respect to a conventional fan (~70 dB). Noise is an important issue for transformers. Noise reduction enables to place the transformers close to residential areas etc.
The separation of the impeller-motor device 10 and the fluid discharge device 12 also makes it possible to protect the moving parts, e.g., impeller-motor device 10, from harsh environmental conditions such as snow, rain, lightning, storm etc.
Flexibility on material, e.g., metal and/or composite, choice.
Robust construction of the cooling arrangement 20 with no moving parts.
High reliability because the cooling arrangement does not have tear and wearable components, and hence, much longer life than bladed fans can be expected.
The cooling arrangement 20 will not have dust deposition causing cleaning difficulties.
The cooling arrangement 20 can work in a wide range of weather temperatures (−40 C to +60 C).
For the OAEHEs such as radiators, the cooling arrangement 20 will not block the vertical fluid flow (natural convection). The cooling arrangement 20 can be placed beneath the existing OAEHEs to produce increased cooling range (forced convection), which enables increase in power rating of the existing transformer. Radiator ONAN and OFAN can be turned into ONAF and OFAF, respectively; by applying the cooling arrangement 20 below the OAEHE to achieve forced convection.
The cooling arrangement 20 can enable a new design of OAEHEs with reduced footprint. Reducing footprint means smaller number of radiators or smaller radiator bank.
Multiple fluid discharge devices 12 can be fed from a powerful single impeller-motor device 10 via a fluid-duct branching system.
If desired, the funnel 15 or a flow director can be connected as a flow-guide, ensuring that all, or most of, the fluid humidity passes through the OAEHE.
The overall weight of the transformer will be reduced, by improved cooling efficiency reducing external OAEHE size.
Oil for transformer cooling can be reduced due to better external cooling efficiency.
Simple and easy manufacturing.
Reduced maintenance because most of the components are encapsulated, and personal risks during maintenance operation is eliminated.
It is safe for humans and/or animals.

It is to be noted that any feature of any of the aspects may be applied to any other aspect, wherever appropriate. Likewise, any advantage of any of the aspects may apply to any of the other aspects.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

It will be appreciated that the foregoing description and the accompanying drawings represent non-limiting examples of the method taught herein. As such, techniques taught herein are not limited by the foregoing description and accompanying drawings. Instead, the embodiments herein are limited only by the following claims and their legal equivalents.

1. A cooling arrangement for cooling at least one oil-to-air external heat exchanger, OAEHE, in a transformer, the cooling arrangement comprising at least one impeller-motor device, at least one fluid pipe and
at least one fluid discharge device, the at least one fluid discharge device comprising a fluid inlet for receiving a humidity-controlled fluid from the at least one fluid pipe, and at least one fluid outlet arranged to direct the humidity-controlled fluid towards the OAEHE, the at least one impeller-motor device being adapted to supply the humidity-controlled fluid to the inlet of the at least one fluid discharge device via the at least one fluid pipe and cause the humidity-controlled fluid to flow through the at least one fluid outlet of the at least one fluid discharge device in a direction of the at least one OAEHE.

2. The cooling arrangement according to claim 1, wherein a fluid humidity is controlled by boosting a humidity content of the fluid.

3. The cooling arrangement according to claim 1, wherein the fluid humidity is controlled by providing a constant humidity to the fluid.

4. The cooling arrangement according to claim 1, wherein a temperature of the humidity-controlled fluid is controlled.

5. The cooling arrangement according to claim 1, wherein the cooling arrangement comprises a device and wherein the humidity-controlled fluid is generated by the device before being provided to the impeller-motor device.

6. The cooling arrangement according to claim 1, wherein the humidity content to the fluid is added after being provided to the at least one impeller-motor device and before reaching the inlet of the at least one fluid discharge device.

7. The cooling arrangement according to claim 1, wherein the cooling arrangement comprises a funnel.

8. The cooling arrangement according to claim 7, wherein the at least one fluid discharge device is arranged in the funnel, wherein the funnel comprises round smooth borders at an inlet of the funnel to facilitate a Coandă effect, which mitigates edge turbulence and reduces pressure drop at the inlet of the funnel.

9. Method performed by a cooling arrangement for cooling at least one oil-to-air external heat exchanger, OAEHE, in a transformer, the cooling arrangement comprising at least one impeller-motor device, at least one fluid pipe and at least one fluid discharge device comprising a fluid inlet for receiving a humidity-controlled fluid from the at least one fluid pip, and at least one fluid outlet, the method comprising:
supplying the humidity-controlled fluid into the at least one fluid pipe, using the at least one impeller-motor device;
transporting the humidity-controlled fluid along the at least one fluid pipe to the inlet of the at least one fluid discharge device;
causing the humidity-controlled fluid to flow through the at least one fluid discharge device; and
discharging the humidity-controlled fluid through the at least one fluid outlet in a direction of the at least one OAEHE.

10. The method according to claim 9, wherein the humidity-controlled fluid is controlled by boosting a humidity content of the fluid.

11. The method according to claim 9, wherein humidity-controlled fluid is controlled by providing a constant humidity to the fluid.

12. The method according to claim 9, wherein a temperature of the humidity-controlled fluid is controlled.

13. The method according to claim 9, further comprises:
generating a filtered humidity-controlled fluid to the at least one impeller-motor device.

14. The method according to claim 9, wherein the humidity-controlled fluid is generated by a device before being provided to the impeller-motor device.

15. The method according to claim 9, further comprises:
adding additional humidity-controlled fluid to an axial region of the fluid discharge device with a hose.

16. A transformer comprising:
an oil-to-air external heat exchanger, OAEHE; and
a cooling arrangement comprising:
at least one impeller-motor device, at least one fluid pipe; and
at least one fluid discharge device, the at least one fluid discharge device comprising a fluid inlet for receiving a humidity-controlled fluid from the at least one fluid pipe, and at least one fluid outlet arranged to direct the humidity-controlled fluid towards the OAEHE, the at least one impeller-motor device being adapted to supply the humidity-controlled fluid to the inlet of the at least one fluid discharge device via the at least one fluid pipe and cause the humidity-controlled fluid to flow through the at least one fluid outlet of the at least one fluid discharge device in a direction of the at least one OAEHE.

17. The transformer according to claim 16, wherein a fluid humidity is controlled by boosting a humidity content of the fluid.

18. The transformer according to claim 16, wherein the fluid humidity is controlled by providing a constant humidity to the fluid.

19. The transformer according to claim 16, wherein a temperature of the humidity-controlled fluid is controlled.

20. The transformer according to claim 16, wherein the cooling arrangement comprises a device and wherein the humidity-controlled fluid is generated by the device before being provided to the impeller-motor device.
